(19) United States
(12) Patent Application Publication
(10) Pub. No.: US 2016/0140966 A1
(43) Pub. Date: May 19, 2016

(54) Portable speech transcription, interpreter and calculation device

(71) Applicant: Sylvia Ann Mines, Jamaica, NY (US)

(72) Inventor: Sylvia Ann Mines, Jamaica, NY (US)

(21) Appl. No.: 14/544,014

(22) Filed: Nov. 14, 2014

(51) Int. Cl. G10L 15/26; G10L 17/22

(52) U.S. Cl. CPC G10L 15/26; G10L 17/22

(57) ABSTRACT

A portable speech transcription and calculation device generates text and algorithmic solutions in response to speech commands. The device includes a speaker for recording speeches, an automatic speech recognition processor to generate text from recorded speeches, a formatting processor to format the text into a desired style, an algorithmic processor for calculating algorithms, and a display device to return the corresponding texts to the respective users. The device is efficacious in transcribing a speech command into text. The text may then display onto a display screen, print from an attached printer, transmit to a portable storage device, or transfer to a remote processor through email or facsimile. Complex algorithmic and accounting calculations may also be performed in response to the speech command. Eliminating the need for input devices such as keyboards reduces stress on the hand and wrist. Handicapped and blind users may also benefit from the device.

### FIELD OF THE INVENTION

The present invention relates generally to a portable speech transcription, interpreter and calculation device. More specifically, the present invention provides a portable speech transcription, interpreter and calculation device that generates text and algorithmic solutions in response to speech commands.

### BACKGROUND OF THE INVENTION

Speech recognition is technology that can translate spoken words into text. Some speech recognition systems use “training” where an individual speaker reads sections of text into the speech recognition system. These systems analyze the person's specific voice and use it to fine tune the recognition of that person's speech, resulting in more accurate transcription.

Dictation software uses a built-in dictionary to match recorded speech with text. A user speaks into the computer's microphone, and the software transcribes the text as the user speaks. The user can then review the text in the word processor or application. The software also recognizes formatting and navigation commands: saying “dot,” for example, can insert a period, or saying “start scrolling down” can scroll to the bottom of the page. Initially, the software will recognize most words, but users can improve the software's accuracy further through recognition training sessions. These “teach” the program to recognize a specific user's pronunciations.

Text to speech, or text-to-speech, processors are computer processing systems that use speech synthesis, or the artificial production of human speech. Text to speech processors allow people with reading disabilities or visual impairments to listen to text inputted or stored in a computer system.

Even though the above cited speech recognition devices address some of the needs of the market, a portable speech transcription and calculation device that generates text and algorithmic solutions in response to speech commands is still desired.

### SUMMARY OF THE INVENTION

This invention is directed to a portable speech transcription and calculation device that generates text and algorithmic solutions in response to speech commands. The portable speech transcription and calculation device includes a speaker for recording speeches, an automatic speech recognition processor to generate text from recorded speeches, a formatting processor to format the text into a desired style, an algorithmic processor for calculating algorithms, and a display device to return the corresponding texts to the respective users. The portable speech transcription and calculation device is efficacious in transcribing a speech command into text. The text may then display onto a display screen, print from an attached printer, transmit to a portable storage device, or transfer to a remote processor through email or facsimile. The display device on the portable speech transcription and calculation device folds into a compact position for efficient storage and carrying. Complex algorithmic calculations may also be performed in response to the speech command. The algorithmic calculations may be substantially more complicated than simple math, and include algebra, calculus, and graphing capabilities. In one embodiment, the algorithmic processor may include a fifteen or seventeen digit accounting calculator for providing accounting capabilities. In another embodiment, the portable speech transcription and calculation device may include a printer and paper feeder for printing spoken text, or calculated algorithms. By eliminating the need for an input device such as, but not limited to, a keyboard or mouse, stress on the hand and wrist are reduced. Further, handicap and blind users may benefit from the portable speech transcription and calculation device. The portable speech transcription and calculation device may be utilized in a variety of environments, including a home, an office, a courtroom, a diplomatic office, and a warehouse.

A first aspect of the present invention provides a portable speech transcription and calculation device comprising:
a housing;
at least one speaker terminal for recording the speech command;
at least one speech recognition processor to generate text from the speech command;
at least one formatting processor to format text from the speech command;
at least one algorithm calculation processor to calculate algorithms from the speech command, wherein at least one speech recognition processor, at least one formatting processor, and at least one algorithm calculation processor are operatively coordinated; and
a display device, the display device being operative to display corresponding text to respective users.

In a second aspect, the portable speech transcription and calculation device generates text and algorithmic solutions in response to speech commands.

In another aspect, the portable speech transcription and calculation device is portable and compacts into a storable position.

In another aspect, the portable speech transcription and calculation device includes Wi-Fi capabilities.

In another aspect, the portable speech transcription and calculation device includes email and facsimile capabilities.

In another aspect, the portable speech transcription and calculation device includes at least one data storage device terminal for exchanging data with at least one portable storage device.

In another aspect, the speaker terminal is a microphone operatively connected to the speech recognition processor.

In another aspect, the speech recognition processor is adapted to improve recognition accuracy for a user using selected data of the speech command and the corresponding texts of at least one other user.

In another aspect, the speech recognition processor includes voice fingerprint recognition software to recognize a specific user based on voice and speech pattern.

In another aspect, the speech recognition processor comprises a different language model for identifying a plurality of languages.

In another aspect, the speech recognition processor displays text in a plurality of languages.

In another aspect, the speech recognition processor discerns between speech commands to be regurgitated, and algorithmic commands to be calculated.

In another aspect, the formatting processor is adapted to format text into at least one style and at least one font using selected data of the speech command.

In another aspect, the formatting processor formats text into basic styles and fonts upon recognition of the appropriate speech command.

In another aspect, the algorithm calculation processor includes an arithmetic logic unit for generating graphical representations of x, y, and z coordinates, wherein the display device displays a corresponding curve.

In another aspect, the algorithm calculation processor calculates, simple math, algebra, differential equations, derivatives, trigonometry upon recognition of the appropriate speech command.

In another aspect, the algorithm calculation processor graphs the calculated resultant for simple math, algebra, differential equations, derivatives, trigonometry upon recognition of the appropriate speech command.

In yet another aspect of one possible embodiment, in operation, the user would position the portable speech transcription and calculation device into the open position with the display device viewable and the speaker terminal in proximity to the user's mouth. The user would then select the desired language that the user would give the speech command in. In some embodiments, the user would select this option either by giving a speech command, such as, but not limited to, “English speech”, “English text display”, or select a Translator button on a touch screen display device. The user has the option of inputting a specific language, receiving a specific language as output, or both options. The user would then select the desired format for the text that would display on the display device. The user would select this option either by giving a speech command, such as, but not limited to, “Arial Font”, “12 point”, “Bold”, or select a Word Processor button on the touch screen display device. The user would then give a speech command for text. The text would appear on the display device. The user would then give a desired algorithmic calculation. The user would select this option either by giving a speech command, such as, but not limited to, “x squared plus three x equals twenty-four. What is x”, followed by “graph the last equation as a curve”, or select a Calculator button on a touch screen display device. The display device would then display an x, y graphed curve. The user would then select the desired form of data transmission to and from the portable speech transcription and calculation device comprising. The user would select this option either by giving a speech command, such as, but not limited to, “Email, johndoe@me.com”, “Fax, 555-555-5555”, or insert a portable storage device, such as, but not limited to, a USB into the data storage device terminal.

In some embodiments, the user may then insert paper into the paper feeder on the portable speech transcription and calculation device. The text displayed on the display device may be printed from a printer attached to the portable speech transcription and calculation device. In one alternative embodiment, the user may give a speech command indicating the color of ink used by the printer. In yet another embodiment, the user may collect the printed paper from a paper tray attached to the portable speech transcription and calculation device. Finally, the user would fold the display device onto the portable speech transcription and calculation device in a storable position.

Accordingly, an objective of the present invention is to eliminate the need for input devices, such as a keyboard or mouse, for word processing.

A further objective of the present invention is to provide printed text that correlates to a speech command.

A further objective of the present invention is to calculate and print an algorithm in response to a speech command.

A further objective of the present invention is to translate a speech command into a text representation of a different language.

Yet a further objective of the present invention is to reduce stress on the hands and wrists.

Yet a further objective of the present invention is to facilitate word processing for handicap and blind users.

These and other advantages of the invention will be further understood and appreciated by those skilled in the art by reference to the following written specification, claims and appended drawings.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 presents a detailed perspective view of a portable speech transcription and calculation device in the closed position, according to an embodiment of the present invention;

FIG. 2 presents a detailed perspective view of the portable speech transcription and calculation device with the display device open and a portable data storage device inserting into a data storage device terminal, according to an embodiment of the present invention;

FIG. 3 presents a top view of the display device showing options for word processing, translating, calculating, and transmitting speech commands, according to an embodiment of the present invention;

FIG. 4 presents a top view of the display device showing options for selecting different font sizes for the text, according to an embodiment of the present invention;

FIG. 5 presents a top view of the display device showing options for selecting different letter formats for the text, according to an embodiment of the present invention; and

FIG. 6 presents a top view of the display device showing options for selecting different languages from a different language model, according to an embodiment of the present invention.

Like reference numerals refer to like parts throughout the various views of the drawings.

### DETAILED DESCRIPTION OF THE INVENTION

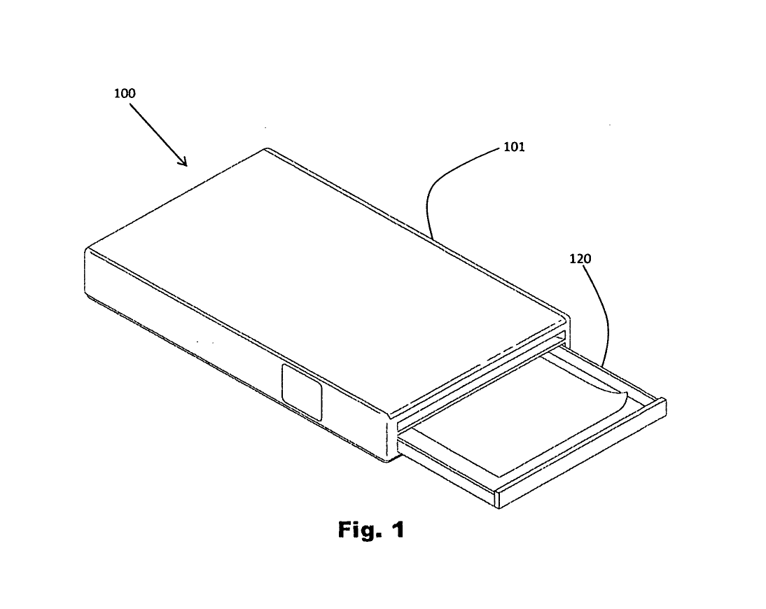

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

A portable speech transcription and calculation device 100 is described in FIGS. 1 through 6, according to one embodiment and multiple views of the present invention. The portable speech transcription and calculation device 100 is an assembly comprising: a housing 101 for providing structural integrity to the portable speech transcription and calculation device 100. The housing 101 provides a protective cover for other components in the portable speech transcription and calculation device 100. The housing 101 may be fabricated from materials, including, but not limited to, plastic, steel, silicone, aluminum, and PVC. In some embodiments, the portable speech transcription and calculation device 100 includes at least one speaker terminal 102 for recording the speech command. At least one speaker terminal 102 may include a microphone that is efficacious in receiving and transmitting sound signals from a speech command.

FIG. 1 illustrates an exemplary portable speech transcription and calculation device 100 that includes at least one speaker terminal 102 operatively connected to at least one speech recognition processor 104 to transcribe text from a speech command. At least one speech recognition processor 104 may include a computer chip having sufficient processing capabilities to, without limitation, transcribe a speech command into text, translate a speech command into a different language, and convert an algorithmic calculation speech command into text. In some embodiments, a speech command, such as, but not limited to, “Spanish speech”, “French text display”, or selecting a Translator button on a touch screen display device may dispose at least one speech recognition processor 104 that includes a different language model 118 to display corresponding text in the desired language. In yet another embodiment, inputting a specific language, receiving a specific language as output or both options may also be processed by at least one speech recognition processor 104, with the desired format for the text displaying on the display device 110. Those skilled in the art, in light of the present teachings will recognize that the foreign language translation features may be efficacious in a court of law for assisting judges, lawyers, plaintiffs, and defendants during testimony.

In a further example of at least one speech recognition processor 104 processing a speech command, giving a speech command, such as, but not limited to, “Arial Font”, “12 point”, “Bold”, or selecting a Word Processor button on the touch screen display device 110 would produce text in corresponding format. In another exemplary embodiment, a desired algorithmic calculation would be spoken into the portable speech transcription and calculation device 100. A possible algorithmic speech command may include, without limitation, “x squared plus three x equals twenty-four. What is x”, followed by “graph the last equation as a curve”, or selecting a Calculator button on a touch screen display device 110. In another embodiment, the display device may then display an x, y graphed curve on the display device 110.

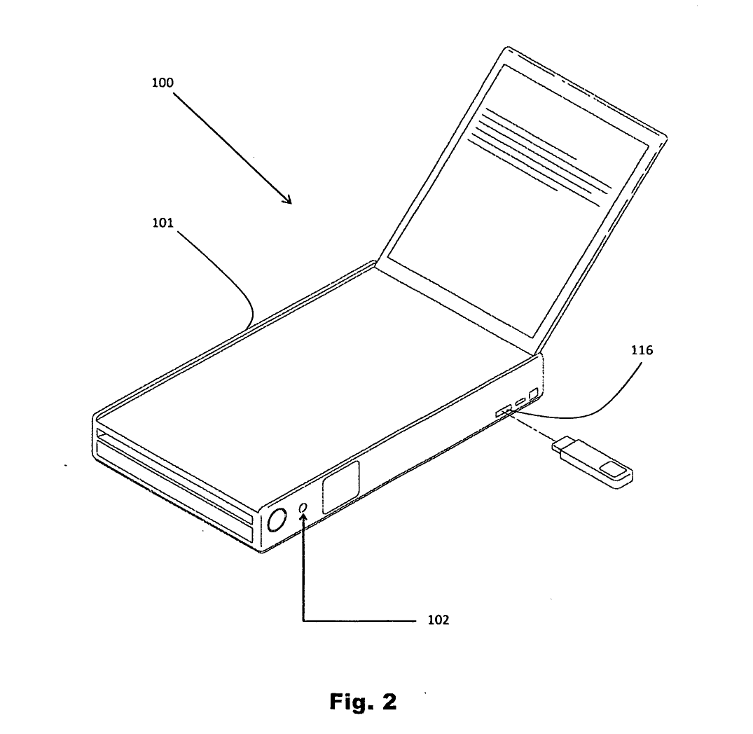

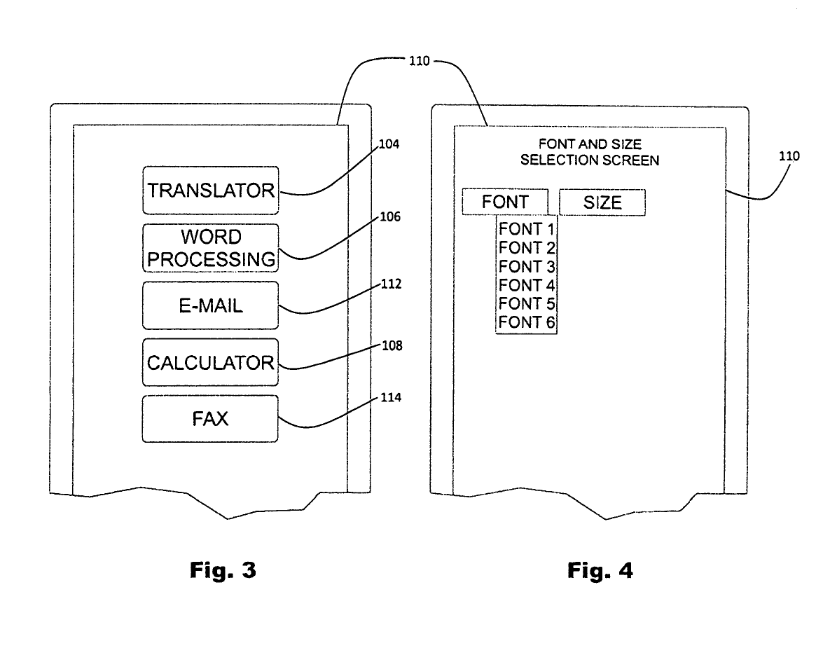

FIG. 2 illustrates an exemplary portable speech transcription and calculation device 100 that includes a portable data storage device inserting into at least one data storage device terminal 116. Those skilled in the art, in light of the present teachings, will recognize that the portable data storage device may include, without limitation, a USB, a CD, a floppy disk, and a wireless cloud. An example of a plurality of buttons on the portable speech transcription and calculation device 100 used to access at least one speech recognition processor 104, at least one formatting processor 106, and at least one algorithm calculation processor 108 is illustrated by way of example in FIG. 3. In one embodiment, selecting “Translator” or “Word Processor” may cause at least one speech recognition processor to transcribe speech into numerous different formats, languages, and styles. In some embodiments, selecting “Calculator” may cause at least one algorithm calculator processor 108 to calculate an algorithm. In yet another embodiment, selecting “Email” 112 or “Fax” 114 may cause the portable speech transcription and calculation device 100 to utilize Wi-Fi capabilities to transmit the desired text to a remote processor.

In one alternative embodiment, at least one speech recognition processor 104 includes a speech-to-text software programs that may allow a user to navigate and control a word processor through voice recognition. A user may surf the internet, check the time, open applications and scroll webpages using built-in vocal commands which the speech-to-text software recognizes.

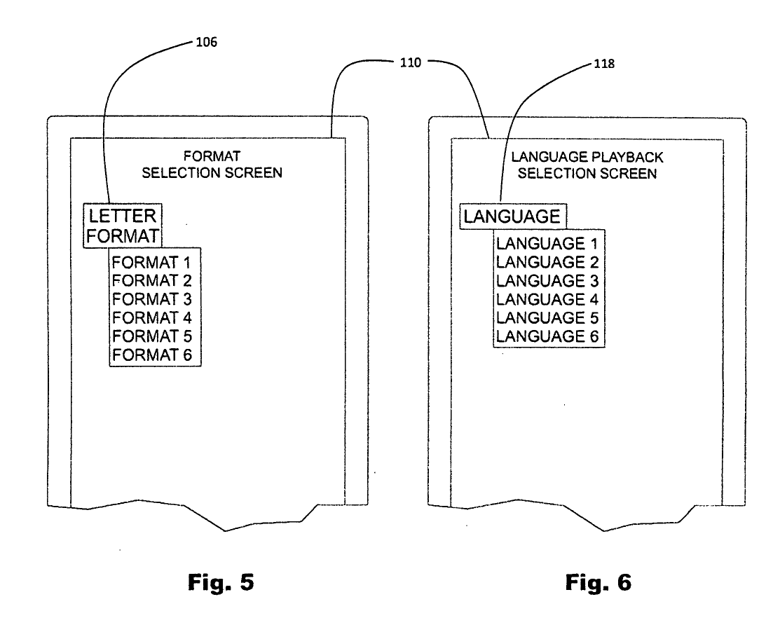

In some embodiments, referenced in FIG. 4, the portable speech transcription and calculation device 100 may include at least one formatting processor 106 to format the font size, style, tabs, and other physical representation of text from the speech command. Possible formats may include, without limitation, “eight point”, or “twenty-four point”. An option to format the letters of the displayed text is illustrated by way of example in FIG. 5. Possible formats may include, without limitation, “Arial”, or “Times”. An option of inputting a specific language, receiving a specific language as output, or both options is illustrated in FIG. 6. In one embodiment, selecting from different languages in the different language model 118, such as, but not limited to, “English speech”, “German text display”, or selecting a Translator button on a touch screen display device 110 provides the translation. At least one algorithm calculation processor 108 may calculate algorithms from the speech command, wherein at least one speech recognition processor 104, at least one formatting processor 106, and at least one algorithm calculation processor 108 are operatively coordinated. In some embodiments, at least one algorithm calculation processor 108 may include an arithmetic logic unit for generating graphical representations of x, y, and z coordinates, wherein the display device 110 displays a corresponding curve. In yet another embodiment, at least one algorithm calculation processor calculates, simple math, algebra, differential equations, derivatives, trigonometry upon recognition of the appropriate speech command. In yet another embodiment of the present invention, the algorithm calculation processor 108 may include a fifteen or seventeen digit accounting calculator for tabulating a specific commercial activity such as billing, payroll, or ledger. However, various other types of calculators may be utilized in the portable speech transcription and calculation device 100.

In some embodiments, the portable speech transcription and calculation device 100 may include a display device 110. The display device 110 is operative to display corresponding text from a speech command. Text and graphical representations may display on the display device 110. The displayed text may also print on an attached printer. Those skilled in the art will recognize that possible display devices 110 may include, without limitation, a touch screen, an LCD screen, and a plasma screen. The display device 110 on the portable speech transcription and calculation device 100 folds into a compact position for efficient storage and carrying.

In some alternative embodiments, a paper feeder on the portable speech transcription and calculation device 100 receives paper for printing text displayed on the display device 110 or spoken. The text displayed on the display device 110 may be printed from a printer attached to the portable speech transcription and calculation device 100. In one alternative embodiment, a speech command may indicate a desired color of ink used by the printer. In yet another embodiment, a paper tray 120 attached to portable speech transcription and calculation device may collect the printed paper.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing speech recognition word processors according to the present invention will be apparent to those skilled in the art. Various aspects of the invention have been described above by way of illustration, and the specific embodiments disclosed are not intended to limit the invention to the particular forms disclosed. The particular implementation of the portable speech transcription and calculation device 100 may include speech recognition and complicated algorithm processing, and may vary depending upon the particular context or application. By way of example, and not limitation, the portable speech transcription and calculation device 100 described in the foregoing was principally directed to assisting a user having difficulties typing or wishing to save time; however, similar techniques may instead be applied to a robotic device for receiving speech commands, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

I claim:

1. A speech transcription and calculation device for generating text and calculating algorithms for a user in accordance with a speech command, the speech transcription and calculation device comprising:
a housing;
at least one speaker terminal for recording the speech command;
at least one speech recognition processor to generate text from the speech command;
at least one formatting processor to format text from the speech command;
at least one algorithm calculation processor to calculate algorithms from the speech command, wherein at least one speech recognition processor, at least one formatting processor, and at least one algorithm calculation processor are operatively coordinated; and
a display device, the display device being operative to display corresponding text to respective users.

2. The speech transcription and calculation device of claim 1, wherein at least one speech recognition processor is adapted to improve recognition accuracy for a user using selected data of the speech command and the corresponding texts of at least one other user.

3. The speech transcription and calculation device of claim 1, wherein the speech command comprises an identifier associated with it corresponding to subject matter area and/or user accent.

4. The speech transcription and calculation device of claim 1, wherein the speech recognition processor comprises a different language model for identifying a plurality of languages.

5. The speech transcription and calculation device of claim 1, wherein the speech recognition processor learns the probabilities of word occurrences dependent on subject matter area.

6. The speech transcription and calculation device of claim 1, wherein at least one formatting processor is adapted to format text into at least one style and at least one font using selected data of the speech command.

7. The speech transcription and calculation device of claim 1, wherein at least one algorithm calculation processor is adapted to calculate an algorithm using selected data of the speech command.

8. The speech transcription and calculation device of claim 1, wherein at least one algorithm calculation processor comprises an arithmetic logic unit, the arithmetic logic unit being operable to generate algorithmic calculations in binary coded form.

9. The speech transcription and calculation device of claim 1, wherein at least one algorithm calculation processor comprises an arithmetic logic unit for calculating derivatives, wherein the communication terminal displays the corresponding text.

10. The speech transcription and calculation device of claim 1, wherein at least one algorithm calculation processor comprises an arithmetic logic unit for calculating algebraic functions.

11. The speech transcription and calculation device of claim 1, wherein at least one algorithm calculation processor comprises an arithmetic logic unit for generating graphical representations of x, y, and z coordinates, wherein the display device displays a corresponding curve.

12. The speech transcription and calculation device of claim 1, wherein at least one algorithm calculation processor comprises a fifteen or seventeen digit accounting calculator.

13. The speech transcription and calculation device of claim 1, wherein the speech transcription and calculation device further comprises Wi-Fi capabilities.

14. The speech transcription and calculation device of claim 1, wherein the speech transcription and calculation device further comprises a paper tray for printing.

15. The speech transcription and calculation device of claim 1, wherein the speech transcription and calculation device further comprises a paper feeder.

16. The speech transcription and calculation device of claim 1, wherein the speech transcription and calculation device further comprises a pivotally hinged display device.

17. A speech transcription and calculation device for generating text and calculating algorithms for a user in accordance with a speech command, the speech transcription and calculation device comprising:
means for delivering a speech command;
means for recording the speech command;
means for processing the speech command to generate text from the speech command;
means for processing the speech command to format text from the speech command;
means for processing the speech command to calculate an algorithm from the speech command; and
means for displaying the corresponding text for the speech command.
